(19) United States
(12) Patent Application Publication
(10) Pub. No.: US 2018/0315112 A1
(43) Pub. Date: Nov. 1, 2018

(54) SYSTEMS AND METHODS FOR DYNAMIC PICK TIME ESTIMATION AND REAL-TIME ORDER DELAY MANAGEMENT

(71) Applicant: WAL-MART STORES, INC., Bentonville, AR (US)

(72) Inventors: Austin Lee Smith, Burlingame, CA (US); Vidyanand Krishnan, Sunnyvale, CA (US); Michael Gilbert Ebener, San Francisco, CA (US); Pratosh Deepak Rajkhowa, Bangalore (IN); Deepak Deshpande, San Jose, CA (US); Arnon Katz, San Mateo, CA (US)

(73) Assignee: WAL-MART STORES, INC., Bentonville, AR (US)

(21) Appl. No.: 15/582,305

(22) Filed: Apr. 28, 2017

(51) Int. Cl. G06Q 30/06; G06Q 10/06

(52) U.S. Cl. CPC G06Q 30/0635; G06Q 10/083; G06Q 10/063116

(57) ABSTRACT

Systems and methods including one or more processing modules and one or more non-transitory storage modules storing computing instructions configured to run on the one or more processing modules and perform acts of receiving an order comprising items for sale at a store, coordinating displaying an order promise time to the customer, automatically determining in real-time an estimated order completion time using at least a dynamic pick time estimation for the order, and, if the estimated order completion time is after the order promise time, sending an escalation alert to an employee of the store.

### TECHNICAL FIELD

This disclosure relates generally to systems and methods for real-time management of delivery and/or pickup orders from a store.

### BACKGROUND

Many customers of retail or grocery stores now desire the convenience of having their orders delivered to their homes and/or picking up their already-collected orders at a designated area of the store. These orders are often made by the customers online using a website or mobile application for the store. If, however, the customer has a narrow window of time in which to pick up the order or be at home for delivery of the order, and/or the store has numerous orders to fulfill, a problem with these online orders is providing accurate order completion times to the customer when the customer makes the order on the website or mobile application.

### BRIEF DESCRIPTION OF THE DRAWINGS

To facilitate further description of the embodiments, the following drawings are provided in which:

FIG. 1 illustrates a front elevational view of a computer system that is suitable for implementing various embodiments of the systems disclosed in FIGS. 3 and 5;

FIG. 2 illustrates a representative block diagram of an example of the elements included in the circuit boards inside a chassis of the computer system of FIG. 1;

FIG. 3 illustrates a representative block diagram of a system, according to an embodiment;

FIG. 4 is a flowchart for a method, according to certain embodiments; and

FIG. 5 illustrates a representative block diagram of a portion of the system of FIG. 3, according to an embodiment.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real time” encompasses operations that occur in “near” real time or somewhat delayed from a triggering event. In a number of embodiments, “real time” can mean real time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

### DESCRIPTION OF EXAMPLES OF EMBODIMENTS

A number of embodiments can include a system. The system can include one or more processing modules and one or more non-transitory storage modules storing computing instructions configured to run on the one or more processing modules. The one or more storage modules can be configured to run on the one or more processing modules and perform an act of receiving, from a first electronic device of a customer, an order comprising one or more items for sale at a store. The one or more storage modules can be further configured to run on the one or more processing modules and perform an act of coordinating displaying one or more order promise times on the first electronic device of the customer. The one or more storage modules can be further configured to run on the one or more processing modules and perform an act of receiving, from the first electronic device of the customer, an order promise time selected from the one or more order promise times displayed on the first electronic device of the user. The one or more storage modules can be further configured to run on the one or more processing modules and perform an act of automatically determining in real-time an estimated order completion time using at least a dynamic pick time estimation for the order. The one or more storage modules can be further configured to run on the one or more processing modules and perform an act of, if the estimated order completion time is after the order promise time, sending an escalation alert to a second electronic device of an employee of the store.

Various embodiments include a method. The method can include receiving, from a first electronic device of a customer, an order comprising one or more items for sale at a store. The method also can include coordinating displaying one or more order promise times on the first electronic device of the customer. The method also can include receiving, from the first electronic device of the customer, an order promise time selected from the one or more order promise times displayed on the first electronic device of the user. The method also can include automatically determining in real-time an estimated order completion time using at least a dynamic pick time estimation for the order. The method also can include, if the estimated order completion time is after the order promise time, sending an escalation alert to a second electronic device of an employee of the store.

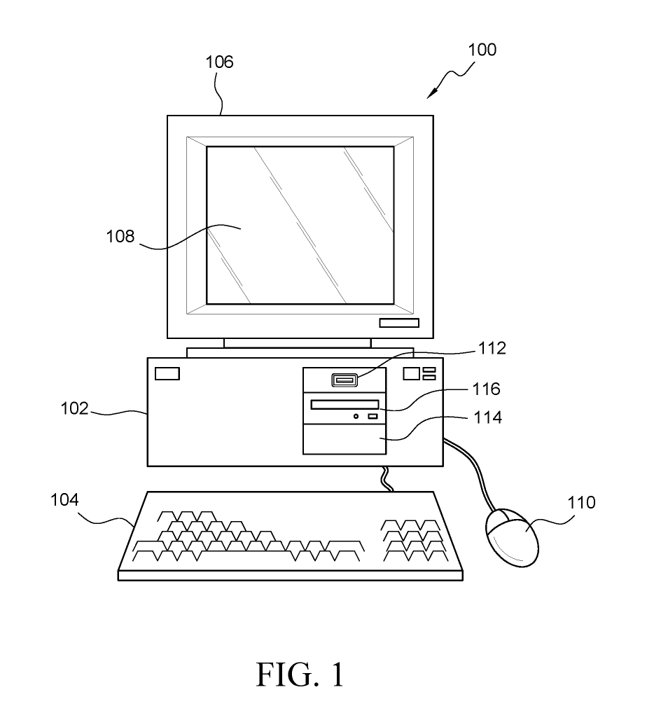

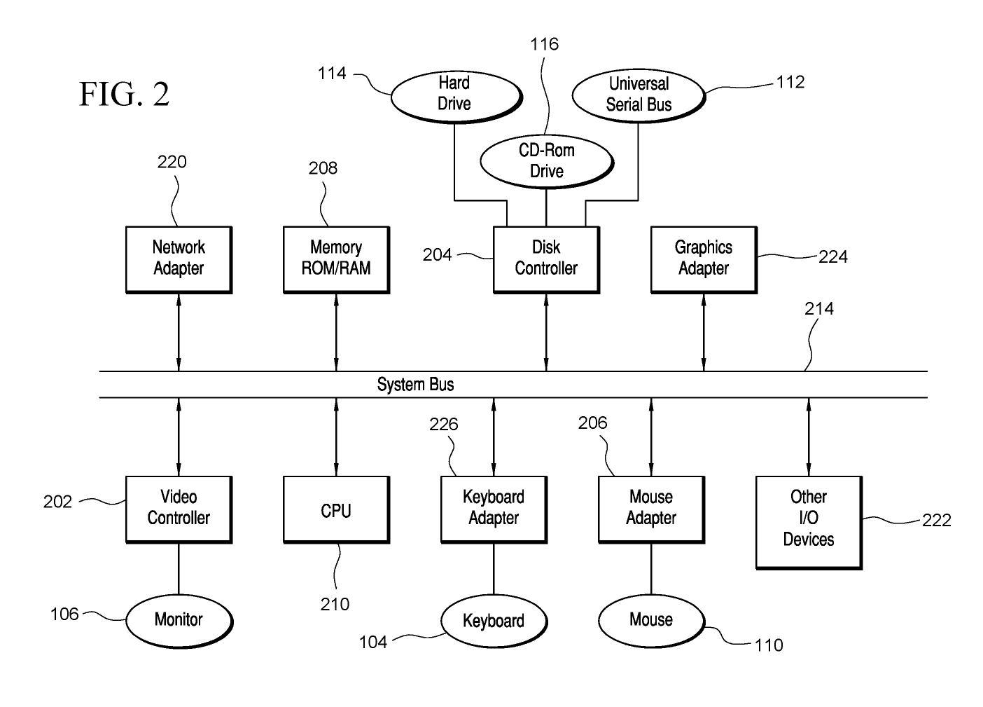

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the memory storage modules described herein. As an example, a different or separate one of a chassis 102 (and its internal components) can be suitable for implementing part or all of one or more embodiments of the techniques, methods, and/or systems described herein. Furthermore, one or more elements of computer system 100 (e.g., a monitor 106, a keyboard 104, and/or a mouse 110, etc.) also can be appropriate for implementing part or all of one or more embodiments of the techniques, methods, and/or systems described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to a memory storage unit 208, where memory storage unit 208 can comprise (i) non-volatile memory, such as, for example, read only memory (ROM) and/or (ii) volatile memory, such as, for example, random access memory (RAM). The non-volatile memory can be removable and/or non-removable non-volatile memory. Meanwhile, RAM can include dynamic RAM (DRAM), static RAM (SRAM), etc. Further, ROM can include mask-programmed ROM, programmable ROM (PROM), one-time programmable ROM (OTP), erasable programmable read-only memory (EPROM), electrically erasable programmable ROM (EEPROM) (e.g., electrically alterable ROM (EAROM) and/or flash memory), etc. In these or other embodiments, memory storage unit 208 can comprise (i) non-transitory memory and/or (ii) transitory memory.

In various examples, portions of the memory storage module(s) of the various embodiments disclosed herein (e.g., portions of the non-volatile memory storage module(s)) can be encoded with a boot code sequence suitable for restoring computer system 100 (FIG. 1) to a functional state after a system reset. In addition, portions of the memory storage module(s) of the various embodiments disclosed herein (e.g., portions of the non-volatile memory storage module(s)) can comprise microcode such as a Basic Input-Output System (BIOS) operable with computer system 100 (FIG. 1). In the same or different examples, portions of the memory storage module(s) of the various embodiments disclosed herein (e.g., portions of the non-volatile memory storage module(s)) can comprise an operating system, which can be a software program that manages the hardware and software resources of a computer and/or a computer network. The BIOS can initialize and test components of computer system 100 (FIG. 1) and load the operating system. Meanwhile, the operating system can perform basic tasks such as, for example, controlling and allocating memory, prioritizing the processing of instructions, controlling input and output devices, facilitating networking, and managing files. Exemplary operating systems can comprise one of the following: (i) Microsoft® Windows® operating system (OS) by Microsoft Corp. of Redmond, Wash., United States of America, (ii) Mac® OS X by Apple Inc. of Cupertino, Calif., United States of America, (iii) UNIX® OS, and (iv) Linux® OS. Further exemplary operating systems can comprise one of the following: (i) the iOS® operating system by Apple Inc. of Cupertino, Calif., United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, Calif., United States of America, (v) the Windows Mobile™ operating system by Microsoft Corp. of Redmond, Wash., United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processing modules of the various embodiments disclosed herein can comprise CPU 210.

Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs. In many embodiments, an application specific integrated circuit (ASIC) can comprise one or more processors or microprocessors and/or memory blocks or memory storage.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to keyboard 104 (FIGS. 1-2) and mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM drive 116 (FIGS. 1-2). In other embodiments, distinct units can be used to control each of these devices separately.

Network adapter 220 can be suitable to connect computer system 100 (FIG. 1) to a computer network by wired communication (e.g., a wired network adapter) and/or wireless communication (e.g., a wireless network adapter). In some embodiments, network adapter 220 can be plugged or coupled to an expansion port (not shown) in computer system 100 (FIG. 1). In other embodiments, network adapter 220 can be built into computer system 100 (FIG. 1). For example, network adapter 220 can be built into computer system 100 (FIG. 1) by being integrated into the motherboard chipset (not shown), or implemented via one or more dedicated communication chips (not shown), connected through a PCI (peripheral component interconnector) or a PCI express bus of computer system 100 (FIG. 1) or USB port 112 (FIG. 1).

Returning now to FIG. 1, although many other components of computer system 100 are not shown, such components and their interconnection are well known to those of ordinary skill in the art. Accordingly, further details concerning the construction and composition of computer system 100 and the circuit boards inside chassis 102 are not discussed herein.

Meanwhile, when computer system 100 is running, program instructions (e.g., computer instructions) stored on one or more of the memory storage module(s) of the various embodiments disclosed herein can be executed by CPU 210 (FIG. 2). At least a portion of the program instructions, stored on these devices, can be suitable for carrying out at least part of the techniques and methods described herein.

Further, although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile electronic device, such as a smartphone. In certain additional embodiments, computer system 100 may comprise an embedded system.

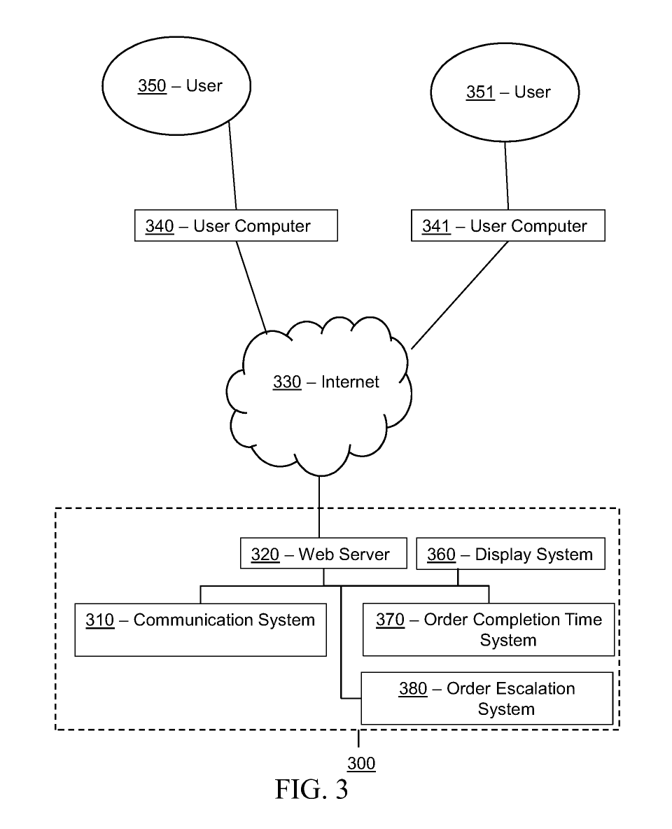

Turning ahead in the drawings, FIG. 3 illustrates a block diagram of a system 300 that can be employed for real-time order delay management, as described in greater detail below. System 300 is merely exemplary and embodiments of the system are not limited to the embodiments presented herein. System 300 can be employed in many different embodiments or examples not specifically depicted or described herein. In some embodiments, certain elements or modules of system 300 can perform various procedures, processes, and/or activities. In these or other embodiments, the procedures, processes, and/or activities can be performed by other suitable elements or modules of system 300.

Generally, therefore, system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

In some embodiments, system 300 can include a communication system 310, a web server 320, a display system 360, an order completion time system 370, and/or an order escalation system 380. Communication system 310, web server 320, display system 360, order completion time system 370, and/or order escalation system 380 can each be a computer system, such as computer system 100 (FIG. 1), as described above, and can each be a single computer, a single server, or a cluster or collection of computers or servers, or a cloud of computers or servers. In another embodiment, a single computer system can host each of two or more of communication system 310, web server 320, display system 360, order completion time system 370, and/or order escalation system 380. In many embodiments, system 300 is an administrator system for a retailer that communicates with one or more computer systems at one or more retail locations. Additional details regarding communication system 310, web server 320, display system 360, order completion time system 370, and order escalation system 380 are described herein.

In many embodiments, system 300 also can comprise user computers 340, 341. In some embodiments, user computers 340, 341 can be mobile devices. A mobile electronic device can refer to a portable electronic device (e.g., an electronic device easily conveyable by hand by a person of average size) with the capability to present audio and/or visual data (e.g., text, images, videos, music, etc.). For example, a mobile electronic device can comprise at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile electronic device can comprise a volume and/or weight sufficiently small as to permit the mobile electronic device to be easily conveyable by hand. For examples, in some embodiments, a mobile electronic device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile electronic device can weigh less than or equal to 15.6 Newtons, 17.8 Newtons, 22.3 Newtons, 31.2 Newtons, and/or 44.5 Newtons.

Exemplary mobile electronic devices can comprise (i) an iPod®, iPhone®, iTouch®, iPad®, MacBook® or similar product by Apple Inc. of Cupertino, Calif., United States of America, (ii) a Blackberry® or similar product by Research in Motion (RIM) of Waterloo, Ontario, Canada, (iii) a Lumia® or similar product by the Nokia Corporation of Keilaniemi, Espoo, Finland, and/or (iv) a Galaxy™ or similar product by the Samsung Group of Samsung Town, Seoul, South Korea. Further, in the same or different embodiments, a mobile electronic device can comprise an electronic device configured to implement one or more of (i) the iPhone® operating system by Apple Inc. of Cupertino, Calif., United States of America, (ii) the Blackberry® operating system by Research In Motion (RIM) of Waterloo, Ontario, Canada, (iii) the Palm® operating system by Palm, Inc. of Sunnyvale, Calif., United States, (iv) the Android™ operating system developed by the Open Handset Alliance, (v) the Windows Mobile™ operating system by Microsoft Corp. of Redmond, Wash., United States of America, or (vi) the Symbian™ operating system by Nokia Corp. of Keilaniemi, Espoo, Finland.

Further still, the term “wearable user computer device” as used herein can refer to an electronic device with the capability to present audio and/or visual data (e.g., text, images, videos, music, etc.) that is configured to be worn by a user and/or mountable (e.g., fixed) on the user of the wearable user computer device (e.g., sometimes under or over clothing; and/or sometimes integrated with and/or as clothing and/or another accessory, such as, for example, a hat, eyeglasses, a wrist watch, shoes, etc.). In many examples, a wearable user computer device can comprise a mobile electronic device, and vice versa. However, a wearable user computer device does not necessarily comprise a mobile electronic device, and vice versa.

In specific examples, a wearable user computer device can comprise a head mountable wearable user computer device (e.g., one or more head mountable displays, one or more eyeglasses, one or more contact lenses, one or more retinal displays, etc.) or a limb mountable wearable user computer device (e.g., a smart watch). In these examples, a head mountable wearable user computer device can be mountable in close proximity to one or both eyes of a user of the head mountable wearable user computer device and/or vectored in alignment with a field of view of the user.

In more specific examples, a head mountable wearable user computer device can comprise (i) Google Glass™ product or a similar product by Google Inc. of Menlo Park, Calif., United States of America; (ii) the Eye Tap™ product, the Laser Eye Tap™ product, or a similar product by ePI Lab of Toronto, Ontario, Canada, and/or (iii) the Raptyr™ product, the STAR 1200™ product, the Vuzix Smart Glasses M100™ product, or a similar product by Vuzix Corporation of Rochester, N.Y., United States of America. In other specific examples, a head mountable wearable user computer device can comprise the Virtual Retinal Display™ product, or similar product by the University of Washington of Seattle, Wash., United States of America. Meanwhile, in further specific examples, a limb mountable wearable user computer device can comprise the iWatch™ product, or similar product by Apple Inc. of Cupertino, Calif., United States of America, the Galaxy Gear or similar product of Samsung Group of Samsung Town, Seoul, South Korea, the Moto 360 product or similar product of Motorola of Schaumburg, Ill., United States of America, and/or the Zip™ product, One™ product, Flex™ product, Charge™ product, Surge™ product, or similar product by Fitbit Inc. of San Francisco, Calif., United States of America.

In some embodiments, web server 320 can be in data communication through Internet 330 with user computers (e.g., 340, 341). In certain embodiments, user computers 340-341 can be desktop computers, laptop computers, smart phones, tablet devices, and/or other endpoint devices. Web server 320 can host one or more websites. For example, web server 320 can host an eCommerce website that allows users to browse and/or search for products, to add products to an electronic shopping cart, and/or to purchase products, in addition to other suitable activities.

In many embodiments, communication system 310, web server 320, display system 360, order completion time system 370, and/or order escalation system 380 can each comprise one or more input devices (e.g., one or more keyboards, one or more keypads, one or more pointing devices such as a computer mouse or computer mice, one or more touchscreen displays, a microphone, etc.), and/or can each comprise one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to the processing module(s) and/or the memory storage module(s) communication system 310, web server 320, display system 360, order completion time system 370, and/or order escalation system 380 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processing module(s) and/or the memory storage module(s). In some embodiments, the KVM switch also can be part of communication system 310, web server 320, display system 360, order completion time system 370, and/or order escalation system 380. In a similar manner, the processing module(s) and the memory storage module(s) can be local and/or remote to each other.

In many embodiments, communication system 310, web server 320, display system 360, order completion time system 370, and/or order escalation system 380 can be configured to communicate with one or more user computers 340 and 341. In some embodiments, user computers 340 and 341 also can be referred to as customer computers. In some embodiments, communication system 310, web server 320, display system 360, order completion time system 370, and/or order escalation system 380 can communicate or interface (e.g., interact) with one or more customer computers (such as user computers 340 and 341) through a network or internet 330. Internet 330 can be an intranet that is not open to the public. Accordingly, in many embodiments, communication system 310, web server 320, display system 360, order completion time system 370, and/or order escalation system 380 (and/or the software used by such systems) can refer to a back end of system 300 operated by an operator and/or administrator of system 300, and user computers 340 and 341 (and/or the software used by such systems) can refer to a front end of system 300 used by one or more users 350 and 351, respectively. In some embodiments, users 350 and 351 also can be referred to as customers, in which case, user computers 340 and 341 can be referred to as customer computers. In these or other embodiments, the operator and/or administrator of system 300 can manage system 300, the processing module(s) of system 300, and/or the memory storage module(s) of system 300 using the input device(s) and/or display device(s) of system 300.

Meanwhile, in many embodiments, communication system 310, web server 320, display system 360, order completion time system 370, and/or order escalation system 380 also can be configured to communicate with one or more databases. The one or more databases can comprise a product database that contains information about products, items, or SKUs (stock keeping units) sold by a retailer. The one or more databases can be stored on one or more memory storage modules (e.g., non-transitory memory storage module(s)), which can be similar or identical to the one or more memory storage module(s) (e.g., non-transitory memory storage module(s)) described above with respect to computer system 100 (FIG. 1). Also, in some embodiments, for any particular database of the one or more databases, that particular database can be stored on a single memory storage module of the memory storage module(s), and/or the non-transitory memory storage module(s) storing the one or more databases or the contents of that particular database can be spread across multiple ones of the memory storage module(s) and/or non-transitory memory storage module(s) storing the one or more databases, depending on the size of the particular database and/or the storage capacity of the memory storage module(s) and/or non-transitory memory storage module(s).

The one or more databases can each comprise a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, communication between communication system 310, web server 320, display system 360, order completion time system 370, order escalation system 380, and/or the one or more databases can be implemented using any suitable manner of wired and/or wireless communication. Accordingly, system 300 can comprise any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can comprise Bluetooth, Zigbee, Wireless Universal Serial Bus (USB), Z-Wave, etc.; exemplary LAN and/or WAN protocol(s) can comprise Institute of Electrical and Electronic Engineers (IEEE) 802.3 (also known as Ethernet), IEEE 802.11 (also known as WiFi), etc.; and exemplary wireless cellular network protocol(s) can comprise Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can comprise wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can comprise wireless communication hardware including, for example, one or more radio transceivers, one or more infrared transceivers, etc. Additional exemplary communication hardware can comprise one or more networking components (e.g., modulator-demodulator components, gateway components, etc.).

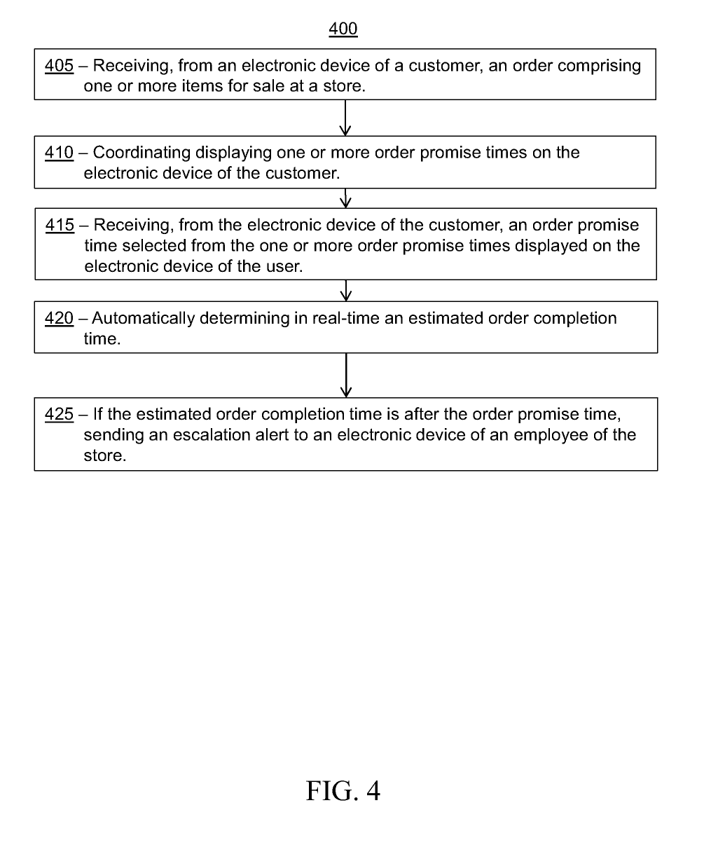

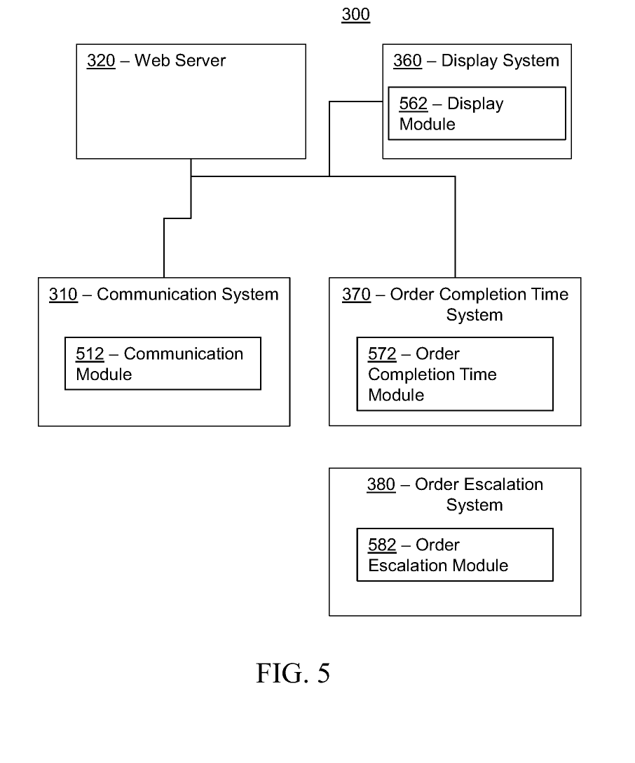

Turning ahead in the drawings, FIG. 4 illustrates a flow chart for a method 400, according to an embodiment. Method 400 is merely exemplary and is not limited to the embodiments presented herein. Method 400 can be employed in many different embodiments or examples not specifically depicted or described herein. In some embodiments, the activities of method 400 can be performed in the order presented. In other embodiments, the activities of method 400 can be performed in any suitable order. In still other embodiments, one or more of the activities of method 400 can be combined or skipped. In many embodiments, system 300 (FIG. 3) can be suitable to perform method 400 and/or one or more of the activities of method 400. In these or other embodiments, one or more of the activities of method 400 can be implemented as one or more computer instructions configured to run at one or more processing modules and configured to be stored at one or more non-transitory memory storage modules 512, 562, 572, and/or 582 (FIG. 5). Such non-transitory memory storage modules can be part of a computer system such as communication system 310, web server 320, display system 360, order completion time system 370, and/or order escalation system 380 (FIGS. 3 & 5). The processing module(s) can be similar or identical to the processing module(s) described above with respect to computer system 100 (FIG. 1).

Method 400 can comprise an activity 405 of receiving, from an electronic device of a customer, an order comprising one or more items for sale at a store. In some embodiments, the store can comprise one or more brick and mortar stores. In other embodiments, the store can comprise one or more online stores, one or more warehouses, and/or one or more distribution centers for one or more online stores, one or more brick and mortar stores, or both. In many embodiments, the order can be received from a customer using his/her electronic device to access a web site or a mobile application for the store.

In various embodiments, the order can comprise an order for pickup by the customer or an order for delivery to the customer. For example, in some embodiments, activity 405 can comprise receiving, from the electronic device of the customer, the order for pickup of the one or more items at the store after the employee of the store has collected the one or more items. In some embodiments, the customer that placed the order can pick up the order from the store.

In an order for delivery of the one or more items, the one or more items are collected at the store by a store associate, and then a store associate, a third-party delivery driver, a drone service, or a self-driving car delivers the one or more items to the agreed upon location for delivery. For example, activity 405 can comprise receiving, from the electronic device of the customer, the order for delivery of the one or more items for sale at the store to the customer at the delivery address. The delivery address can be entered by the customer while shopping for the one or more items, or also can be saved from a previous shopping experience by the customer on the website of the store and/or saved with customer information pertaining to the customer. Method 400, therefore, also can comprise an activity of receiving a delivery address from the customer.

In many embodiments, activity 405 can comprise determining, while the customer is making the order, one or more order promise times using: (1) a dynamic pick time estimation for the order; (2) an estimated driving time from the store to the delivery address; (3) a number and an availability of employees of the store to collect the one or more items of the order; (4) additional orders currently pending or being collected; (5) a dispense wait-time; and/or (5) a time of day, day of the week, and/or a holiday, including a historical average number of orders during a time of day, day of the week, and/or day of the year. In some embodiments, a dispense wait-time can be an amount of time that lapses between a request to receive an order and the time the order is handed over to the person who requested the order. The dispense wait-time can be determined using historical data, current conditions, and/or customer specific details.

In some embodiments the dynamic pick time estimation can be determined using a regression model that is based on one or more of: (1) one or more locations of the one or more items in the store; (2) a number of commodity switches required to collect the one or more items at the store; (3) a historical performance of the employee of the store assigned to collect the one or more items of the order; and/or (4) a time of day when the order is collected at the store by the employee. The number of commodity switches can include the number of times an associate must switch between different commodities in the store to collect the one or more items. For example, a number of times a user must switch from the refrigerated or frozen section of the store to the room temperature section of the store. In some embodiments, the number commodity switches can comprise a number of aisle switches of how many aisle must be traversed in the store based on the item locations within commodity for an associate to collect the order. The time of day can affect the pick time estimation due to the store being more or less crowded at certain times of the day.

In some embodiments, the dynamic pick time estimation can be determined using a regression analysis for estimating the relationships among variables. The regression analysis used can use the relationship between a dependent variable and one or more independent variables (or “predictors”). The regression model can determine how picking time (or the dependent variable or “criterion variable”) can be modeled changes when any one of the independent variables is varied for each order. The independent variables can include, for example, a number of: (1) a total number of ambient, chilled, and/or frozen products; and/or (2) a total number of ambient, chilled, and/or frozen products.

In some embodiments, linear regression can be used where the relationships are modeled using linear predictor functions whose unknown model parameters are estimated from data. For example, given a variable y and a number of variables X₁, . . . , Xₚ that may be related to y, linear regression analysis can be applied to quantify the strength of the relationship between y and the Xⱼ, to assess which Xⱼ may have no relationship with y at all, and to identify which subsets of the Xⱼ contain redundant information about y.

In a non-limiting example, the following was used to determine with all values of A based on historical data, and then used to estimate picking time based on order related variables:

Estimated Picking Time=A1X1, A2X2, A3X3, A4X4, A5X5 . . . AnXn+Constant +Error

where constant is a required value for each estimation, A are coefficients, and X are order related variables that impact picking. Independent variables or order related variables that impact picking time can be determined through techniques of feature selection, and then reducing the independent variables or order related variables to the features that impacted the picking time the most. Information gain for feature selection can be used to select features that are most important to picking time and discard irrelevant or redundant features.

In some embodiments, activity 405 and other activities in method 400 can comprise using a distributed network comprising distributed memory architecture to perform the associated activity. This distributed architecture can reduce the impact on the network and system resources to reduce congestion in bottlenecks while still allowing data to be accessible from a central location. In some embodiments, activity 405 and other activities in method 400 can comprise using a distributed network comprising distributed memory architecture to perform the associated activity. This distributed architecture can reduce the impact on the network and system resources to reduce congestion in bottlenecks while still allowing data to be accessible from a central location.

Method 400 can further comprise an activity 410 of coordinating displaying one or more order promise times on the electronic device of the customer. In some embodiments, the one or more order promise times can be coordinated for display to allow a customer to agree to an order promise time and/or select a certain order time from a plurality order promise times.

Method 400 can further comprise an activity 415 of receiving, from the electronic device of the customer, an order promise time selected from the one or more order promise times displayed on the electronic device of the user. In some embodiments, only a single order promise time is coordinated for display, and activity 415 comprises receiving, from the electronic device of the customer, an agreement to the single order promise time. In other embodiments, method 400 can comprise activities of determining and coordinating displaying a plurality of order promise times on the electronic device of the customer. In these and other embodiments, method 400 also can comprise an activity of receiving a selection of one of the plurality of order promise times from the electronic device of the customer. In these embodiments, the plurality of order promise times for an order can be determined as a plurality of possible order promise times as described above, and the customer can select which order time of the plurality of order times he/she prefers.

In still more embodiments, method 400 can comprise an activity of receiving a preferred order promise time entered by the customer on the electronic device of the customer. In these and other embodiments, method 400 can comprise an activity of determining if the preferred order promise time entered by the customer can be performed by the store. For example, system 300 (FIG. 3) can determine if the preferred order promise time entered by the customer can be performed or completed by the store using: (1) a dynamic pick time estimation for the order; (2) an estimated driving time from the store to the delivery address; (3) a number and an availability of employees of the store to collect the one or more items of the order; (4) additional orders currently pending or being collected; and/or (5) a time of day, day of the week, and/or a holiday, including a historical average number of orders during a time of day, day of the week, and/or day of the year.

Once the order is placed by the customer, method 400 can further comprise an activity 420 of automatically determining in real-time an estimated order completion time. Activity 420 can be performed continuously by system 300 (FIG. 3) for each order of a plurality of orders made by a plurality of customers. For example, system 300 (FIG. 3) can continuously or periodically monitor in real-time a plurality of orders from a plurality of customers to determine what an estimated order completion time is for each order of the plurality of orders. For example, in some embodiments, system 300 (FIG. 3) can determine an estimated order completion time for each order once every 15 seconds, once every 60 seconds, once every 90 seconds, once every 120 seconds, and so on. In many embodiments, method 400 can comprise an activity of determining an estimated completion time for each step of an order. For example, system 300 (FIG. 3) can determine an estimated completion time for collecting the order at the store and also an estimated amount of time required for delivery of the order from the store to the customer.

In many embodiments, activity 420 can comprise automatically determining in real-time the estimated order completion time for delivery of the order to the delivery address using at least one of: (1) the dynamic pick time estimation for the order; (2) an estimated driving time from the store to the delivery address; (3) a picking start time for the order; and/or (4) a location of a delivery driver before picking up the order from the store or after picking up the order from the store. In many embodiments, method 400 can comprise an activity of determining or otherwise tracking a location of the delivery driver before or after picking up the order from the store. Accordingly, activity 420 can further comprise an activity of determining an estimated driving time from the store to the delivery address, an estimated driving time from the location of the driver to the store, and/or an estimated driving time from the location of the driver to the delivery address.

In many embodiments, method 400 can comprise an activity of automatically assigning the order to the employee of the store for collection of the one or more items of the order at the store. For example, system 300 (FIG. 3) can automatically assign the order to one or more associates for collection of the order at the store by the one or more associates. Method 400 also can comprise an activity of: (1) assigning the order to an employee of the store for delivery of the order to the customer; or (2) contacting a third-party delivery service for delivery of the order from the store to the customer. In some embodiments, the third-party delivery service can comprise a crowd-sourced delivery service.

Method 400 can further comprise an activity 425 of, if the estimated order completion time is after the order promise time, sending an escalation alert to an electronic device of an employee of the store. In some embodiments, the employee of the store to whom the escalation alert is sent is a manager of the store. In other embodiments, the employee of the store to whom the escalation alert is sent is an associate of the store assigned to collect the order at the store and/or deliver the order to the customer. In still other embodiments, the escalation alert is sent to electronic devices of both the manager of the store and/or the associate of the store assigned to collect the order at the store and/or deliver the order to the customer. In many embodiments, method 400 can comprise an activity of coordinating displaying the escalation alert on the electronic device of the employee of the store and/or an administrator of store operations for the store at a location that is remote from the store.

In some embodiments, the escalation alert indicates a time by which the employee needs to finish collecting the one or more items of the order to meet the order promise time. Method 400 also can optionally comprise an activity of, if the estimated order completion is after the order promise time, automatically assigning the order to a different employee of the store and/or assigning an additional employee of the store to collect the order. For example, if collection of the order is behind schedule, system 300 (FIG. 3) can automatically assign two or more employees to collect the order.

In some embodiments, method 400 can optionally comprise an activity of receiving a notification when a delivery driver is at the store and ready to deliver the order to the customer. In other embodiments, method 400 can optionally comprise an activity of tracking a location of a delivery driver and recording when the delivery driver is at the store and ready to deliver the order to the customer. In these and other embodiments, method 400 can optionally comprise an activity of sending an additional alert that the delivery driver is at the store and ready to deliver the order to the customer. Furthermore, in these and other embodiments, method 400 can further optionally comprise an activity of sending an additional alert to the electronic device of the employee of the store if the delivery driver has waited for the order at the store for longer than a predetermined period of time. For example, if the delivery driver has waited for the order at the store for five minutes or longer, system 300 (FIG. 3) can transmit an additional alert to the electronic device of the manager of the store that the delivery driver has been waiting for five or more minutes.

In some embodiments, method 400 can comprise an activity of tracking the delivery driver after the delivery driver has picked up the order from the store and is en route to deliver the order to the customer. If the delivery driver is behind in the estimated driving time, method 400 can optionally comprise an activity of sending an alert to the employee of the store. For example, if the delivery becomes caught in traffic or is otherwise delayed during delivery of the order to the customer, system 300 (FIG. 3) can alert an employee of the store, who then can notify the customer.

As noted above, in many embodiments, method 400 can comprise an activity of determining an estimated completion time for each step of an order. If the estimated completion time for collecting the order is after an expected completion time for the order, method 400 can optionally comprise an activity of automatically sending a notification to the delivery driver that collection of the order is behind. In these and other embodiments, method 400 can optionally comprise an activity of determining an updated pickup time for the delivery driver to pick up the order at the store, and also transmitting the updated pickup time to the delivery driver.

In many embodiments, method 400 can optionally comprise an activity of automatically sending a notification to the customer if the estimated order completion is after the order promise time. In some embodiments, the notification includes the estimated order time that is after the order promise time, while in other embodiments the notification only notifies the customer that the order has been delayed.

FIG. 5 illustrates a block diagram of a portion of system 300 comprising communication system 310, web server 320, display system 360, order completion time system 370, and order escalation system 380, according to the embodiment shown in FIG. 3. Each of communication system 310, web server 320, display system 360, order completion time system 370, and order escalation system 380, is merely exemplary and not limited to the embodiments presented herein. Each of communication system 310, web server 320, display system 360, order completion time system 370, and order escalation system 380, can be employed in many different embodiments or examples not specifically depicted or described herein. In some embodiments, certain elements or modules of communication system 310, web server 320, display system 360, order completion time system 370, and/or order escalation system 380, can perform various procedures, processes, and/or acts. In other embodiments, the procedures, processes, and/or acts can be performed by other suitable elements or modules.

In many embodiments, communication system 310 can comprise non-transitory storage module 512. Memory storage module 512 can be referred to as communication module 512. In many embodiments, communication module 512 can store computing instructions configured to run on one or more processing modules and perform one or more acts of method 400 (FIG. 4) (e.g., activity 405 of receiving, from an electronic device of a customer, an order comprising one or more items for sale at a store, and activity 415 of receiving, from the electronic device of the customer, an order promise time selected from the one or more order promise times displayed on the electronic device of the user (FIG. 4)).

In many embodiments, display system 360 can comprise non-transitory storage module 562. Memory storage module 562 can be referred to as display module 562. In many embodiments, display module 562 can store computing instructions configured to run on one or more processing modules and perform one or more acts of method 400 (FIG. 4) (e.g., activity 410 of coordinating displaying one or more order promise times on the electronic device of the customer (FIG. 4)).

In many embodiments, order completion time system 370 can comprise non-transitory storage module 572. Memory storage module 572 can be referred to as order completion time module 572. In many embodiments, order completion time module 572 can store computing instructions configured to run on one or more processing modules and perform one or more acts of method 400 (FIG. 4) (e.g., activity 420 of automatically determining in real-time an estimated order completion time (FIG. 4)).

In many embodiments, order escalation system 380 can comprise non-transitory storage module 582. Memory storage module 582 can be referred to as order escalation module 582. In many embodiments order escalation module 582 can store computing instructions configured to run on one or more processing modules and perform one or more acts of method 400 (FIG. 4) (e.g., activity 425 of, if the estimated order completion time is after the order promise time, sending an escalation alert to an electronic device of an employee of the store (FIG. 4)).

Although systems and methods for real-time order delay management have been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-5 may be modified, and that the foregoing discussion of certain of these embodiments does not necessarily represent a complete description of all possible embodiments. For example, one or more of the procedures, processes, or activities of FIG. 4 may include different procedures, processes, and/or activities and be performed by many different modules, in many different orders.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
one or more processing modules; and
one or more non-transitory storage modules storing computing instructions configured to run on the one or more processing modules and perform acts of:
receiving, from a first electronic device of a customer, an order comprising one or more items for sale at a store;
coordinating displaying one or more order promise times on the first electronic device of the customer;
receiving, from the first electronic device of the customer, an order promise time selected from the one or more order promise times displayed on the first electronic device of the user;
automatically determining in real-time an estimated order completion time using at least a dynamic pick time estimation for the order; and
if the estimated order completion time is after the order promise time, sending an escalation alert to a second electronic device of an employee of the store.

2. The system of claim 1, wherein automatically determining in real-time the estimated order completion time comprises automatically determining in real-time the estimated order completion time using the dynamic pick time estimation for the order and a picking start time for the order.

3. The system of claim 1, wherein sending the escalation alert to the second electronic device comprises sending the escalation alert to the second electronic device of the employee of the store assigned to collect the order at the store.

4. The system of claim 1, wherein receiving the order comprises receiving, from the first electronic device of the customer, the order for pickup of the one or more items at the store after the employee of the store has collected the one or more items.

5. The system of claim 1, wherein:
the one or more non-transitory storage modules storing the computing instructions are further configured to run on the one or more processing modules and perform an act of receiving a delivery address from the customer; and
receiving the order comprises receiving, from the first electronic device of the customer, the order for delivery of the one or more items for sale at the store to the customer at the delivery address.

6. The system of claim 5, wherein automatically determining in real-time the estimated order completion time comprises automatically determining in real-time the estimated order completion time for delivery of the order to the delivery address using at least one of: (1) the dynamic pick time estimation for the order, (2) an estimated driving time from the store to the delivery address, (3) a picking start time for the order, or (4) a location of a delivery driver before picking up the order from the store or after picking up the order from the store.

7. The system of claim 6, wherein the one or more non-transitory storage modules storing the computing instructions are further configured to run on the one or more processing modules and perform an act of sending an additional alert to the second electronic device of the employee of the store if the delivery driver has waited for the order at the store for longer than a predetermined period of time.

8. The system of claim 5, wherein the one or more non-transitory storage modules storing computing instructions are further configured to run on the one or more processing modules and perform an act of determining, while the customer is making the order, the one or more order promise times using: (1) the dynamic pick time estimation for the order and (2) an estimated driving time from the store to the delivery address.

9. The system of claim 1, wherein:
the one or more non-transitory storage modules storing computing instructions are further configured to run on the one or more processing modules and perform acts of:
automatically assigning the order to the employee of the store for collection of the one or more items of the order at the store; and
sending a notification to the customer if the estimated order completion time is after the order promise time; and
the dynamic pick time estimation is based on: (1) one or more locations of the one or more items in the store, (2) a number of commodity switches required to collect the one or more items at the store, (3) a historical performance of the employee of the store assigned to collect the one or more items of the order, and (4) a time of day when the order is collected at the store by the employee.

10. The system of claim 1, wherein:
the dynamic pick time estimation is based on: (1) one or more locations of the one or more items in the store, (2) a number of commodity switches required to collect the one or more items at the store, (3) a historical performance of the employee of the store assigned to collect the one or more items of the order, and (4) a time of day when the order is collected at the store by the employee;
sending the escalation alert to the second electronic device comprises sending the escalation alert to the second electronic device of the employee of the store assigned to collect the order at the store;
the one or more non-transitory storage modules storing the computing instructions are further configured to run on the one or more processing modules and perform an act of receiving a delivery address from the customer;
receiving the order comprises receiving, from the first electronic device of the customer, the order for delivery of the one or more items for sale at the store to the customer at the delivery address;
automatically determining in real-time the estimated order completion time comprises automatically determining in real-time the estimated order completion time for delivery of the order to the delivery address using at least one of: (1) the dynamic pick time estimation for the order, (2) an estimated driving time from the store to the delivery address, (3) a picking start time for the order, or (4) a location of a delivery driver before picking up the order from the store or after picking up the order from the store; and
the one or more non-transitory storage modules storing the computing instructions are further configured to run on the one or more processing modules and perform acts of:
sending an additional alert to the second electronic device of the employee of the store if the delivery driver has waited for the order at the store for longer than a predetermined period of time;
determining, while the customer is making the order, the one or more order promise times using: (1) the dynamic pick time estimation for the order and (2) an estimated driving time from the store to the delivery address;
automatically assigning the order to the employee of the store for collection of the one or more items of the order at the store; and
sending a notification to the customer if the estimated order completion time is after the order promise time.

11. A method comprising:
receiving, from a first electronic device of a customer, an order comprising one or more items for sale at a store;
coordinating displaying one or more order promise times on the first electronic device of the customer;
receiving, from the first electronic device of the customer, an order promise time selected from the one or more order promise times displayed on the first electronic device of the user;
automatically determining in real-time an estimated order completion time using at least a dynamic pick time estimation for the order; and
if the estimated order completion time is after the order promise time, sending an escalation alert to a second electronic device of an employee of the store.

12. The method of claim 11, wherein automatically determining in real-time the estimated order completion time comprises automatically determining in real-time the estimated order completion time using the dynamic pick time estimation for the order and a picking start time for the order.

13. The method of claim 11, wherein sending the escalation alert to the second electronic device comprises sending the escalation alert to the second electronic device of the employee of the store assigned to collect the order at the store.

14. The method of claim 11, wherein receiving the order comprises receiving, from the first electronic device of the customer, the order for pickup of the one or more items at the store after the employee of the store has collected the one or more items.

15. The method of claim 11, wherein:
the method further comprises receiving a delivery address from the customer; and
receiving the order comprises receiving, from the first electronic device of the customer, the order for delivery of the one or more items for sale at the store to the customer at the delivery address.

16. The method of claim 15, wherein automatically determining in real-time the estimated order completion time comprises automatically determining in real-time the estimated order completion time for delivery of the order to the delivery address using at least one of: (1) the dynamic pick time estimation for the order, (2) an estimated driving time from the store to the delivery address, (3) a picking start time for the order, or (4) a location of a delivery driver before picking up the order from the store or after picking up the order from the store.

17. The method of claim 16, further comprising sending an additional alert to the second electronic device of the employee of the store if the delivery driver has waited for the order at the store for longer than a predetermined period of time.

18. The method of claim 15, further comprising determining, while the customer is making the order, the one or more order promise times using: (1) the dynamic pick time estimation for the order and (2) an estimated driving time from the store to the delivery address.

19. The method of claim 11, wherein:
the method further comprises:
automatically assigning the order to the employee of the store for collection of the one or more items of the order at the store; and
sending a notification to the customer if the estimated order completion time is after the order promise time; and
the dynamic pick time estimation is based on: (1) one or more locations of the one or more items in the store, (2) a number of commodity switches required to collect the one or more items at the store, (3) a historical performance of the employee of the store assigned to collect the one or more items of the order, and (4) a time of day when the order is collected at the store by the employee.

20. The method of claim 11, wherein:
the dynamic pick time estimation is based on: (1) one or more locations of the one or more items in the store, (2) a number of commodity switches required to collect the one or more items at the store, (3) a historical performance of the employee of the store assigned to collect the one or more items of the order, and (4) a time of day when the order is collected at the store by the employee;
sending the escalation alert to the second electronic device comprises sending the escalation alert to the second electronic device of the employee of the store assigned to collect the order at the store;
the method further comprises receiving a delivery address from the customer;
receiving the order comprises receiving, from the first electronic device of the customer, the order for delivery of the one or more items for sale at the store to the customer at the delivery address;
automatically determining in real-time the estimated order completion time comprises automatically determining in real-time the estimated order completion time for delivery of the order to the delivery address using at least one of: (1) the dynamic pick time estimation for the order, (2) an estimated driving time from the store to the delivery address, (3) a picking start time for the order, or (4) a location of a delivery driver before picking up the order from the store or after picking up the order from the store; and
the method further comprises:
sending an additional alert to the second electronic device of the employee of the store if the delivery driver has waited for the order at the store for longer than a predetermined period of time;
determining, while the customer is making the order, the one or more order promise times using: (1) the dynamic pick time estimation for the order and (2) an estimated driving time from the store to the delivery address;
automatically assigning the order to the employee of the store for collection of the one or more items of the order at the store; and
sending a notification to the customer if the estimated order completion time is after the order promise time.
